(19) United States
(12) Patent Application Publication
(10) Pub. No.: US 2015/0221244 A1
(43) Pub. Date: Aug. 6, 2015

(54) MODIFIABLE DISPLAY DEVICES AND SYSTEMS

(71) Applicant: MILLER RESORT LLC, Diamond Bar, CA (US)

(72) Inventors: John Miller, Santa Monica, CA (US); Brian Miller, Irvine, CA (US); Amber Bartels, Irvine, CA (US); Caroline Campbell, Santa Monica, CA (US)

(21) Appl. No.: 14/429,054

(22) PCT Filed: Sep. 18, 2013
(86) PCT No.: PCT/US2013/060414

§ 371 Date: Mar. 18, 2015

Related U.S. Application Data
(60) Provisional application No. 61/702,715, filed on Sep. 18, 2012.
(60) Provisional application No. 61/730,758, filed on Nov. 28, 2012.
(60) Provisional application No. 61/731,019, filed on Nov. 29, 2012.
(60) Provisional application No. 61/739,121, filed on Dec. 19, 2012.

(51) Int. Cl. G09F 9/30; G06Q 50/18; G06Q 30/00; G09G 3/32; G09G 3/34

(52) U.S. Cl. CPC G09F 9/301; G09G 3/3208; G09G 3/344; G06Q 30/018; G06Q 50/184; G09G 2330/02; G09G 2380/02; G09G 2320/10

(57) ABSTRACT

A modifiable display device may include a wearable article, a power supply arranged on the wearable article, an active element arranged on a surface of the wearable article, and a controller in electrical communication with the power supply and the active element and configured to control the appearance of the active element.

### FIELD OF THE INVENTION

The present disclosure relates to electronic displays. More particularly, the present disclosure relates to electronic displays that may be flexible and formable into one of several positions. Still more particularly, the present disclosure relates to several articles, including wearable articles, that may incorporate flexible displays. Still more particularly, the present disclosure relates to methods and systems for licensing the displays and/or content shown on the displays.

### BACKGROUND

Items and articles we wear and/or use day-to-day are typically of a particular design. For example, clothing typically involves a particular design including the way that it fits and the colors and designs it includes on an outer surface. These designs, once established, are commonly static and do not provide the owner or user of the articles the flexibility to adjust the design. Accordingly, to obtain such flexibility, users may purchase and/or own multiple types of clothing, accessories, or other articles outside of clothing each having various designs.

Recently, a variety of new technologies have emerged that enable flexible displays. Flexible displays include (but are not limited to) liquid crystal displays (LCD), organic light emitting diode (OLED), and electrophoretic displays (EPD, also known as “E-Paper”). For example, Samsung Electronics has demonstrated color AM-OLED displays that are flexible. These displays have been implemented in common electrical formats including mobile devices and wrist watches, for example.

### SUMMARY

In one embodiment, a modifiable display device may include a wearable article, a power supply arranged on the wearable article, and an active element arranged on a surface of the wearable article. The device may also include a controller in electrical communication with the power supply and the active element and the controller may be configured to control the appearance of the active element.

In another embodiment, a modifiable display device may include a molded product, a power supply arranged on the molded product, and an active element arranged on a surface of the molded product. The device may also include a controller in electrical communication with the power supply and the active element. The controller may be configured to control the appearance of the active element.

In still other embodiments, a system for managing content and intellectual property rights therein for modifiable display devices may include a central database having content stored thereon. The content may be associated with an identification. The system may also include a registration confirmation module stored on the database and adapted to receive information over a network. The registration module may compare the information to content and associated identifications in the database and confirm registration with the system. The system may also include a license module configured to establish a license between a user and an owner of copyright of the content.

In other embodiments, novel methods for making, uses of, and applications for wearable display products are provided. In still other embodiments, a process for making, uses of, and applications for molded display products are provided. In still other embodiments, a system and methods for enabling individuals to license their intellectual property rights to third parties for use in wearable display products and molded display products are provided.

In still other embodiments, a mobile app through which an individual can upload dynamic content to a wearable display product or molded display product and interact may be provided. The mobile app may allow the individual or organization to invite friends to upload dynamic content to a wearable display product or molded display product.

### BRIEF DESCRIPTION OF THE FIGURES

While the specification concludes with claims particularly pointing out and distinctly claiming the subject matter that is regarded as forming the various embodiments of the present disclosure, it is believed that the invention will be better understood from the following description taken in conjunction with the accompanying Figures.

FIG. 1 shows a schematic diagram of a circuit of an article of the present system.

FIGS. 2A and 2B each show a flexible display article in the form of a neck tie, according to some embodiments.

FIG. 3 shows a flexible display article in the form of footwear, according to some embodiments.

FIGS. 4A-4C each show a flexible display article in the form of a wallet, according to some embodiments.

FIGS. 5A and 5B each show a flexible display article in the form of a molded product, according to some embodiments.

### DETAILED DESCRIPTION

The present disclosure, in some embodiments, relates to articles incorporating controllable displays and/or elements. In some cases, wearable articles, such as clothing, footwear, accessories, or other items a person may wear may include controllable displays and/or elements such that the article's appearance is not static, but is instead dynamic and/or adjustable. For example, in some embodiments, the color of the article may be adjusted. In other embodiments, more elaborate displays of the article may be adjusted to show various types of content. The color or content may, thus, be selected for particular circumstances including clothing coordination, venue, occasion, and the like. In some particular cases, for example, an article, such as a shoe, belt, or other wearable element, may be adapted such that the user may change its color to create a particular look including a coordinated, clashing, or otherwise personally created look. In other cases, an article may include a display that is programmed to show content. The display may also be re-programmable to show alternative content based on a situation, a mood, or just the desire of a user. Other articles aside from wearable articles, and in particular, molded products may also include controllable displays and/or elements. Still further, these concepts may proliferate the number of publicly available displays present in society and, as such, a system and method for licensing the content on such displays is also envisaged and described herein.

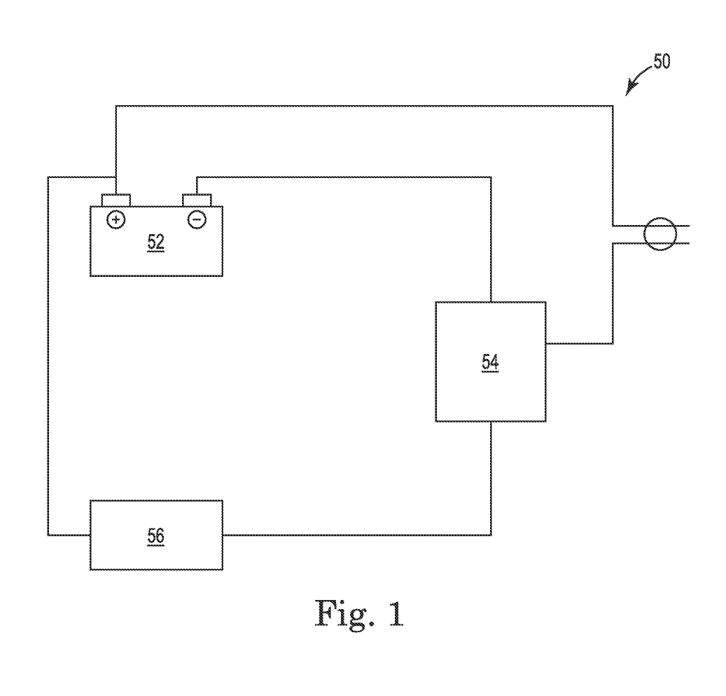

FIG. 1 shows a schematic diagram of a circuit of an article of the present system. As shown in FIG. 1, the circuit 50 may include a power supply 52, a controller 54, and an active element 56. This circuit 50 and/or parts thereof may be arranged in, on, and/or around an article and may be configured to allow the article to be dynamic in appearance in lieu of an otherwise static article with an otherwise pre-selected color, design, message, or other display. The circuit 50 may be rigid or flexible and each of the elements may include a wide range of sophistication depending on the desired ability of adjustment. For example, the power supply 52 may include one or a plurality of several different types of batteries and may be rechargeable or replaceable. In some embodiments, the controller 54 may include a switch, a resistance adjustment, a circuit, or the controller 54 may include a computing device capable of receiving and storing data and performing instructions that may be pre-programmed and/or programmable. The active element 56 may be a color changing conductor, or the active element 56 may include a display such as an LED, LCD, or other controllable display and the active element 56 may be flexible. Still other configurations of the circuit 50 may be provided depending on desired sophistication and/or adaptation of the article.

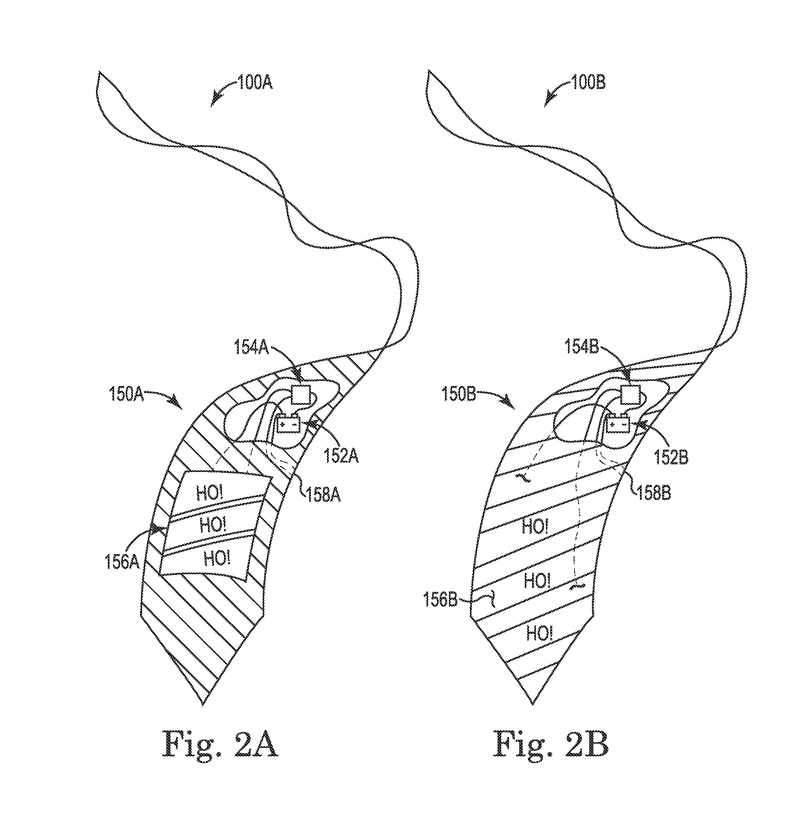

FIGS. 2A and 2B show embodiments of wearable articles 100A/B in the form of neckties, according to some embodiments. Ties have been worn by men (and sometimes women) for generations. Ties may be worn in professional settings and may often be worn with suits. Many ties are made out of silk or other textile materials. Ties may be manufactured in a variety of ways, with the most expensive ties commonly being made by hand. Ties may differ in their specific shapes, sizes, and designs. Indeed, there are hundreds of designer tie labels. In some embodiments, the tie may be a bowtie or the tie may be more elongated hanging necktie. Still other types of ties may include scarves and other textile elements worn around the neck.

Individuals that wear ties on a regular basis often prefer to own multiple ties so that they can wear different ties with different shirts. This is because known ties have a static design and the same tie does not commonly properly coordinate with different outfits or settings. Additionally, while it is possible for individuals to create their own tie designs, it is expensive and complicated.

In the present embodiment, as shown in FIGS. 2A and 2B, an electronic tie 100A/B may include a circuit 150A/B, that is the same or similar to the circuit 50 of FIG. 1. The circuit 150A/B may be adapted to allow an active element 156A/B of the tie to change based on selections of the wearer. As shown, and like the circuit 50 of FIG. 1, the circuit 150A/B may include a power source 152A/B and a controller 154A/B. The power source 152A/B may be configured to provide power to the circuit 150A/B and the controller 154A/B may be adapted to control the appearance of the active element 156A/B. In some embodiments, as shown in FIG. 2A, the active element 156A may extend over a portion of the tie 100A and in other embodiments as shown in FIG. 2B, the active element 156B may extend over a larger portion or the entire area of the tie 100B including all or a portion of the backside of the tie 100B. In some embodiments, multiple active elements may be provided on the surface of the tie.

The power supply 152A/B may include one of several available or later developed battery or energy storing technologies. In some embodiments, the power supply 152A/B may include a thin film lithium ion battery that can be recharged. For example, as shown in each of FIGS. 2A/B, a recharging port 158A/B such as a micro USB or other charging connection may be provided on the back or near the edge of the tie with circuitry leading back to the power supply 152A/B to allow the power supply to be plugged in and recharged. In other embodiments, the power supply 152A/B may be adapted for recharging by a magnetic or other wireless recharging system. In some embodiments, the charging circuit may pass through the controller 154A/B allowing the controller 154A/B to monitor and/or control charging. In other embodiments the power supply 152A/B may not be rechargeable and a battery replacement area that may include an access panel may be provided for removing and/or replacing the power supply 152A/B. It is to be appreciated that while a lithium ion battery has been discussed, still other types and numbers of batteries may be provided depending on the needs of the system, the battery life desired, and the continually developing battery technologies. For example, in some embodiments, advanced materials may be used for thin-film batteries. In some embodiments, the battery used may be coordinated with the needs of the system, which may depend on the amount and speed of the changing content on the display, the brightness and amount of use of the display, and the overall amount of draw the display may put on the battery. In some embodiments, a relatively small draw may be provided by using displays that do not require a backlight, for example organic LED, or using electrophoretic displays that are reflective and use light from surroundings to project images.

The active element 156A/B may include a conductor adapted to change colors depending on the voltage applied to its surface as described in more detail with respect to the footwear described below. In other embodiments, the active element may include one or a combination of display suitable materials. In some embodiments, the active element may include liquid crystal display (“LCD”) technology, organic LED (“OLED”) technology, and/or electrophoretic display (“EPD” or “E-Paper”) technology. As mentioned with respect to FIGS. 2A and 2B, the display may extend over a portion, several portions, larger portions, or the entire area of the tie.

Depending, in part, on the sophistication of the active element and on other factors, the controller 154A/B may take one of several varying forms. For example, where the active element is a conductor adapted to change colors depending on the voltage applied to its surface, the controller may be a variable resistor, for example, that controls the amount of voltage applied to the conductor in the circuit. The variable resistor may be in the form of a rheostat, for example, or other element to control the circuit voltage and, thus, the color of the conductor.

However, where more control and image detail is desired a more sophisticated active element 156A/B may be provided in the form of an electronic display. In this embodiment, the controller 156A/B may include a circuit, chip, or microcontroller that may be used to control display and provide content for the display. In some embodiments, the controller 156A/B may be a programmable controller 156A/B such that similar controllers 156A/B may be used for different ties and may be programmed to provide different content on the ties. In still other embodiments, the controller 156A/B may be reprogrammable and may allow the user to adjust the content displayed. Accordingly, the controller 156A/B may include a computer readable storage medium that may be adjusted and/or modified to store data. The data may include instructions performable by a processor to control the content of the display. The controller 156A/B may also include inputs and outputs for communicating with external devices for purposes of updating the data stored in the computer readable storage medium. For example, the controller 156A/B may include wired or wireless communication inputs/outputs adapted for one or more different communication protocols including WiFi, Bluetooth, near field communication, and other wireless communication systems and protocols.

In some embodiments, application software may be provided allowing a user to download designs from a source of designs provided by the software or from third parties and upload those designs to the controller 156A/B for display on the tie. In some embodiments, the designs may include stationary messages or the designs may include moving and/or changing messages. In other embodiments no messages or verbal content may be included. In some embodiments, the application software may be available as an app for a smartphone, for example. The smartphone app may allow the user to select from a variety of designs and the app may be configured to communicate with the tie 100A/B to adjust, program, or otherwise control the active element 156A/B.

In some embodiments, one or more of the above technologies may be provided in a rigid condition or one or more of the above technologies may be provided in a flexible condition. In still other embodiments, a combination of rigid and flexible technologies may be used. Flexible electronic materials and films can be used for the active element 156A/B, circuitry 150A/B, controller 154A/B, and the power supply 152A/B. For example, printable organic materials (such as polymers and small molecules) and inorganic materials (such as carbon nanotubes, metal nanowires, and semiconductor nanowires) can be used to fabricate the active layer (e.g. OWED layer), transparent conducting layers, and thin film transistors in the display. Similarly, various advanced materials can be used to make flexible circuitry and thin film batteries. Accordingly, one or more embodiments include an electronic display comprised of a display 156A/B, circuitry 150A/B, and energy storage system 152A/B, where the tie 100A/B is bendable, foldable, and stretchable without impairing the electronic functionality or visual display of the tie 100A/B.

In some embodiments, a flexible, transparent material such as polyethylene terephthalate (“PET”) may be provided for the surface of the tie 100A/B. Various coatings can be deposited on the surface layer such as anti-scratch films, water proof films, and anti-reflective films.

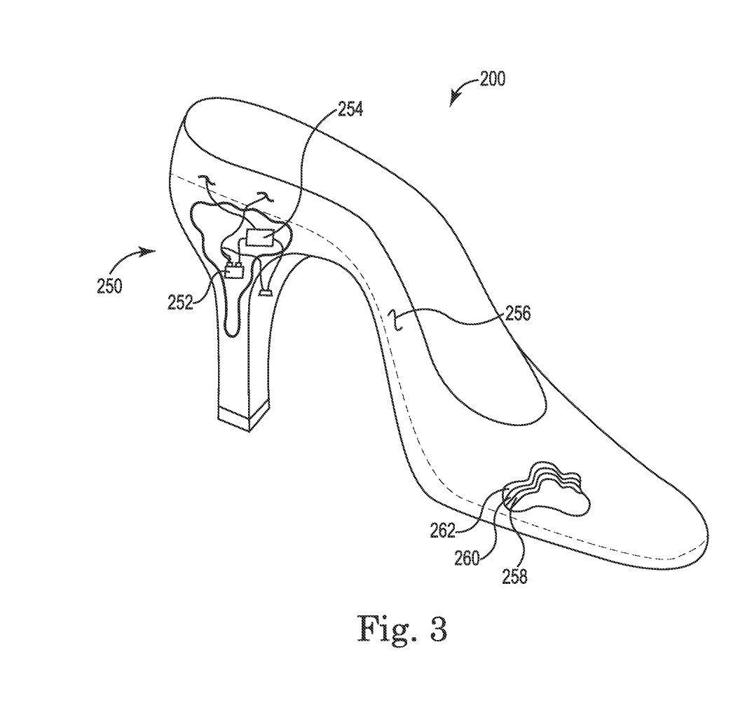

Referring now to FIG. 3, another embodiment of an article 200 is shown. In this embodiment, an article of footwear 200, such as a woman's high-heel shoe, is shown that can display different colors or designs. Like the tie 100A/B described above, the shoe may include circuitry 250 including a power supply 252, a controller 254, and an active element 256 allowing the shoe to change colors, display different designs, or otherwise change its appearance. The article of footwear 200 and the associated circuit 250 may include some or all of the features described with respect to the article 100A/B.

As mentioned with respect to the ties 100A/B, but described in more detail here, in some embodiments, the footwear may be adapted to change colors. In this embodiment, the footwear may include an active element 256 in the form of a multi-layered coating on the surface of the shoe that can be electronically programmed to change colors. The multi-layered coating may include a layer of plastic 258, an active color changing layer 260, and a conductor 262. In one embodiment, the multi-layer coating is fabricated using high speed printing processes. The plastic can be (but is not limited to) PET or polyethylene napthatlate (“PEN”), for example. The color changing layer may include an organic material that changes different colors in response to different electrical charges. In some embodiments, the color changing layer may include an electrochromic polymer. The conductor can be made of a variety of different materials. In one embodiment, the conductor is comprised of a flexible film of carbon nanotubes. The current flowing through the conducting film activates the color changing layer.

Like the tie article 100A/B, a power supply 252 and a controller 254 may be provided to control the active element 256. In some embodiments, the controller 254 may be a relatively simple resistive element or adjustable resistive element such as a concealed dial or slide mechanism for adjusting the voltage seen by the conductor portion of the active element 256, thus, affecting the color of the article 200. However, in other embodiments, the controller 254 may be a more sophisticated circuit, chip, and/or processor allowing the article 200 to communicate with other devices in a wired or wireless fashion and allowing the article 200 to be programmed. For example, in some embodiments, like the tie 100A/B, the article 200 may include an active element 256 in the form of a display and designs or other content may be uploaded to the article 200 for display. Such communication may be with a smartphone or other computing device that has or has downloaded designs or content for display on the article 200.

Like the tie 100A/B, the footwear may include a fully integrated display that can be based on flexible LCD technology or flexible organic LED technology, for example. In one embodiment, the footwear is comprised of a protective plastic coating and a flexible AMOLED panel.

Another embodiment of the invention is a system for facilitating wireless communications between a device such as a smart phone and footwear. The system can utilize existing hardware in smart phones for communication with external devices. For example, near field RFID technology is integrated into many smart phones. The system may include a controller 254 having a chip (or set of chips) integrated into the footwear that can activate the display functions integrated into the footwear.

In still another embodiment, the footwear 200 may serves as a replacement for a smart phone. That is, the footwear may include flexible display technology, flexible touch panel technology, and all of the features currently found in a smart phone such as memory, SIM Card, and processing capabilities, GPS, accelerometers, gyroscopes, and the like.

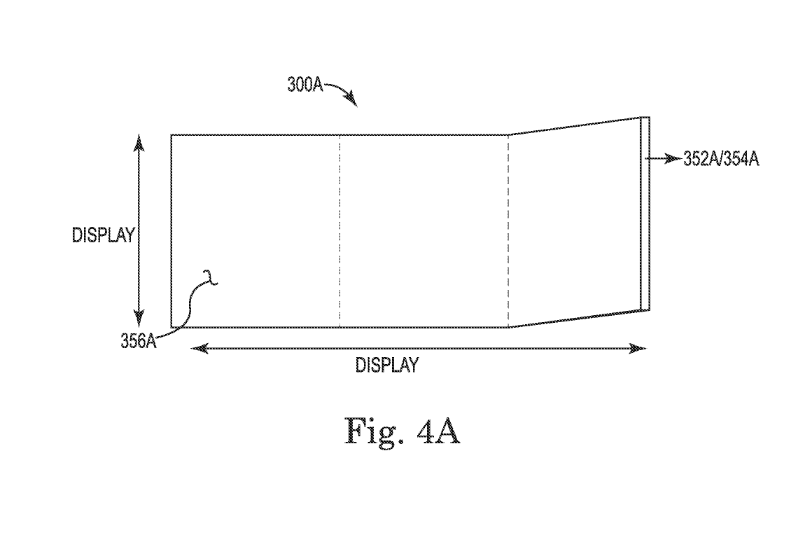

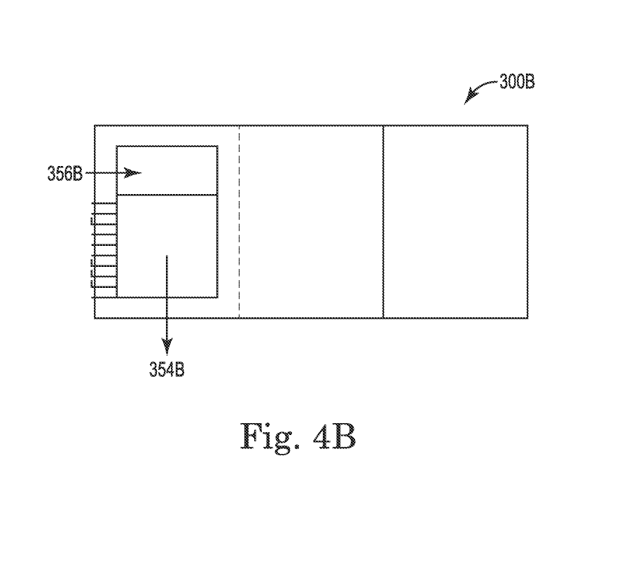

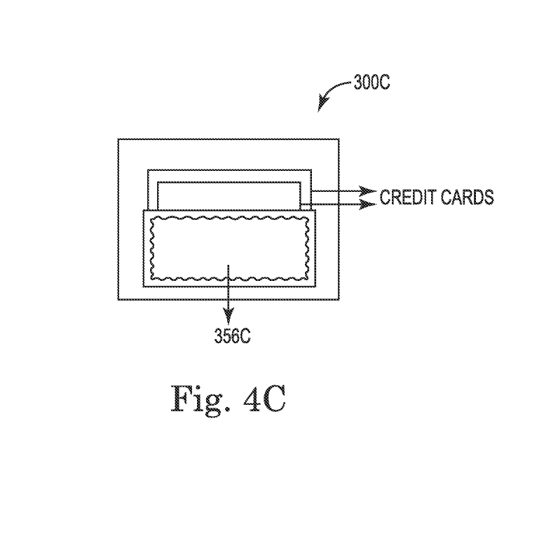

Referring now to FIGS. 4A-4C, yet another embodiment of an article 300 is shown in the form of a wallet. A wallet is a small holding case used for carrying money, documents or other items. Wallets may come in various sizes, shapes, and colors. Many wallets are made of leather while others are made of plastic or rubber. The materials used to fabricate wallets is often highly durable. Wallets are generally subject to stretching, bending, elongation, and other mechanical shocks. Flexible displays have been demonstrated that can bend or fold. However, while these displays can survive some bending, they might not sustain elongation. Accordingly, flexible displays may not be thought of as being capable of integration into wallets.

Flexible, plastic displays such as flexible electrophoretic displays (“EPD”) and flexible OLED displays have been demonstrated. However, due to the fragility of some of the electronic materials used to make these displays, they may be sensitive to and may not sustain elongation. However, new materials such as transparent conductive films made of carbon nanotubes may be used to make passive matrix EPD displays that can sustain elongation.

Accordingly, another embodiment may include a wallet 300A comprising an active element 356A in the form of a display that spans across substantially all of the outer surface of the wallet as shown in FIG. 4A. The display may serve as the outside layer of the wallet, or it may be attached to (either sewn into or glued to) the outer surface of the wallet. The display can be (but is not limited to) an EPD display or an OLED display. In some embodiments, as shown in FIG. 4A, the display driver circuitry 352A/354A may be contained at one edge of the wallet. For example, in FIG. 4A, the display driver circuitry 352A/354A is all located on the right edge of the wallet 300A. The display driver circuitry including a power supply 352A and a controller 354A may be connected to a thin circuit board integrated into the wallet. In FIG. 4B, an example of how the circuit board and energy system might be embedded in the front side of the wallet 300B is shown.

Referring to FIG. 4C, another embodiment may include a wallet 300C comprising a display capable of elongation that is located on a particular part of the wallet. The display may be integrated into the leather cover that holds cards on the inside of the wallet. The circuit board and energy storage 352C/354C might be embedded in the wallet behind the display.

In keeping with the above three embodiments (tie, footwear, wallet) relating to display articles, another embodiment involving paper stickers may be provided. For example, the sticker may include a circuit similar to the circuit 50 of FIG. 1 and/or the circuits 150/250/350 of FIGS. 2-4, for example. Paper stickers can be placed most anywhere, ranging from car bumpers to the wall of a bedroom. In many cases, large paper stickers are used to express one's likes, thoughts, or feelings. For example, people may place bumper stickers on their car that advance political commentary or support a particular sports team. Similarly, children that like pirates might place stickers of pirates on the walls in their bedroom. Stickers include a static appearance and generally are used to communicate a single message. A bumper sticker placed on the back of a car may not, without more, display a different, customized message from moment to moment.

An electronic sticker may include a relatively thin, flexible display that may be directly attached to a surface by a separable attachment. Examples of separable attachments may include adhesives and magnets. The sticker may, thus, be capable of attaching to a non-flat surface. Like the previous embodiments, the electronic sticker may include an active element in the form of a flexible display, a controller in the form of a circuit board, and a power supply in the form of an energy storage system. The electronic sticker may be relatively thin and can be attached to a surface by a separable attachment. Like the above-described embodiments, the flexible display technologies may include flexible LCD, OLED, and EPD. The circuit board can be thin and rigid or flexible. The battery can be a thin, flexible battery. The battery can be capable of being recharged or replaceable. Plastic films such as PET or PEN are used as the front and back surfaces of the electronic sticker. The display can range in thickness from 0.5 millimeter to 5 millimeters.

In some embodiments, an electronic sticker may be provided including an adhesive on the back side and attached to a release liner. When the electronic sticker is removed from the release liner, it can be fastened to a surface. The surface of the sticker can be attached to a non-flat surface. For example, it can be wrapped around sharp angles. The adhesive can be adhesives used to attach traditional, paper stickers to surfaces.

Another embodiment of the invention is an electronic sticker comprising a magnet on the back side. The magnet may be sufficiently thin and, thus flexible, such that the electronic sticker can be attached to a non-flat surface.

Another embodiment may include an electronic sticker for use in the outdoors comprising a solar cell for purposes of supplementing and/or replacing the power supply. Examples of solar cell technologies that might be used, but are not limited to, organic, CIGs, and dye sensitized. In another embodiment, the electronic sticker may include a protective casing for the power supply so that the recharging mechanism for the battery is not subject to rust and other weather related damage.

Unlike ties 100, shoes 200, and wallets, 300, for example, stickers may be more likely to be positioned at a location and left there in the absence of a user. Accordingly, while the sticker may have circuitry for communicating with a user like the other three articles, the sticker may also include an authorization system for enabling third party electronic devices such as smart phones to communicate with an electronic sticker. For example, if a user places an electronic sticker on the refrigerator in the kitchen of a home, he or she may desire multiple parties in the house to be able to use their smart phones to upload content to the electronic sticker. The system may include (1) a mechanism for the owner of the electronic sticker to identify third parties that are authorized to upload content to the electronic sticker; and (2) a mechanism for third parties to submit content to the electronic sticker. Various methods might be used for the owner of the electronic sticker to identify third parties authorized to upload content to the electronic sticker. In one embodiment, the owner of the electronic sticker can go to a web site and provide the identifying information (e.g. a phone number) associated with each mobile device that can upload content to the electronic sticker. The server hosting the web site may communicate directly with the electronic sticker. Several mechanisms might be used for third parties to submit content to the electronic sticker. In one embodiment, each person controlling a mobile device can download an “App” to his or her mobile device. The App may allow the person to submit content such as words, symbols, or pictures to the electronic sticker. The content can be securely transferred from the mobile device to the server and then to the electronic sticker.

Another embodiment may include an electronic patch comprised of an active element, a controller, and a power supply, similar to that of the previous described embodiments. The patch can be completely flexible and bendable or it may have a rigid plastic layer on one end of the patch. The rigid plastic layer can be used to encase the wireless communication system, display drive electronics, energy storage system, and Micro USB connection. The patch can contain an adhesive layer on the back side, so that the patch can be transferred to and firmly attached to several different materials, such as clothing. An example of the adhesive material may include a hook and loop material such as Velcro®. The back side of the patch may also contain clips to attach the patch to different surfaces. In some embodiments, the electronic patch may be approximately 4 inches in length by 2.5 inches in width. The patch may also be less than 1 millimeter in thickness. Still other lengths, widths, and thicknesses may be provided. The top of the electronic patch may include a rigid plastic encasing for a wireless communication system, display drive electronics, energy storage system, and MICRO-USB connection. The display may include a color E-Paper display or one of the other types of displays may be used. The transistors in the display may be flexible and comprised of polymers. The conductors may be flexible and may be carbon nanotube films. The electronic patch may communicate with a mobile device. The mobile device may transmit signals to the electronic patch to display words, pictures, and designs. For example, an individual can transmit his or her Instagram feed to the electronic patch worn on his or her clothes.

In still another embodiment, a hat may include a circuit including a power supply, a controller, and an active element. Like the previous designs, the hat may be programmed to change colors or designs or display pictures or logos.

Turning away from wearable products, we now look at moldable display products. Plastic molding generally refers to a process for making parts out of plastic (e.g. thermoplastic and thermosetting plastic) or other materials (e.g. metals, glasses, elastomers, and confections). Molding processes may include extrusion molding, injection molding, blow molding, thermoforming, rotational molding, casting, foaming, compression molding, transfer molding and other molding processes where a liquid or semi-liquid is formed into a shape and allowed to dry, cure, set or otherwise come to a non-flowing state. Thermoforming involves heating a plastic film or sheet to a pliable forming temperature, forming the sheet to a specific shape in a mold, and cutting the article to create a usable product. Many different products can be made via thermoforming, including cups, lids, and plates.

In some embodiments, displays systems similar to the systems described above may be incorporated into molded products. Different types of plastic might be used including (but not limited) PET, PEN, or polycarbonate. The plastic films can be different thickness and have various properties such as protective layers. Displays capable of withstanding the temperatures and/or pressures associated with the molding process may be incorporated into the products.

Commercial display technologies, as previously mentioned, may include LCD, EPD, and OLED. Examples of flexible LCD, EPD, and OLED displays have been demonstrated. LCD displays require back lighting such as LEDs, so they may not be ideal for thin, flexible displays. EPD displays and OLED displays do not require backlighting. EPD displays operate by using surrounding light and rearranging charged pigment particles using an applied electric field. EPD displays can hold static text and images indefinitely without using electricity. EPD displays have been shown to be flexible. For example, Samsung and Unidym demonstrated 14 inch color, flexible EPD displays. EPD displays can be either passive matrix or active matrix. Passive matrix displays do not have a TFT backplane and are generally lower resolution than active matrix displays. Active matrix displays have a TFT backplane. Active matrix EPD displays can be made flexible using flexible backplanes. OLED displays use an emissive electroluminescent layer sandwiched between two electrodes to emit light in response to an electric current.

To date, there are no reports of displays integrated in plastic parts that have been molded. However, applicant has discovered that the combination of certain materials and processes can be used to make such parts. Traditionally, indium tin oxide (“ITO”) has been used as the transparent conductive film in LCD, EPD, and OLED displays. ITO is a ceramic, and due to its brittle nature, it does not perform well in a thermoforming process. Conductors made of carbon materials such as carbon nanotubes, however, perform much better in a molding process such as thermoforming. For example, a simple passive matrix EPD display with a top electrode comprised of a carbon nanotube (“CNT”) film and a bottom electrode comprised of a CNT film performs well in a thermoforming process and remains functional before and after the thermoforming process.

In keeping with the above, other embodiments may include, a process for making parts comprised of plastic that are molded and incorporate displays is provided. The process may include: (1) forming a stack comprised of a plastic substrate on the top and bottom, with a display between the two plastic substrates that is capable of surviving a thermoforming process; and (2) thermoforming the stack to form a desired shape and configuration. In some embodiments, the stack may be formed, bent, curved, or otherwise shaped to conform to the surface profile of the desired molded product and a surface of the stack may be arranged to coincide with the surface of the molded product such that, after thermoforming, the display is arranged at or near the surface of the molded product and incorporated into the molded product.

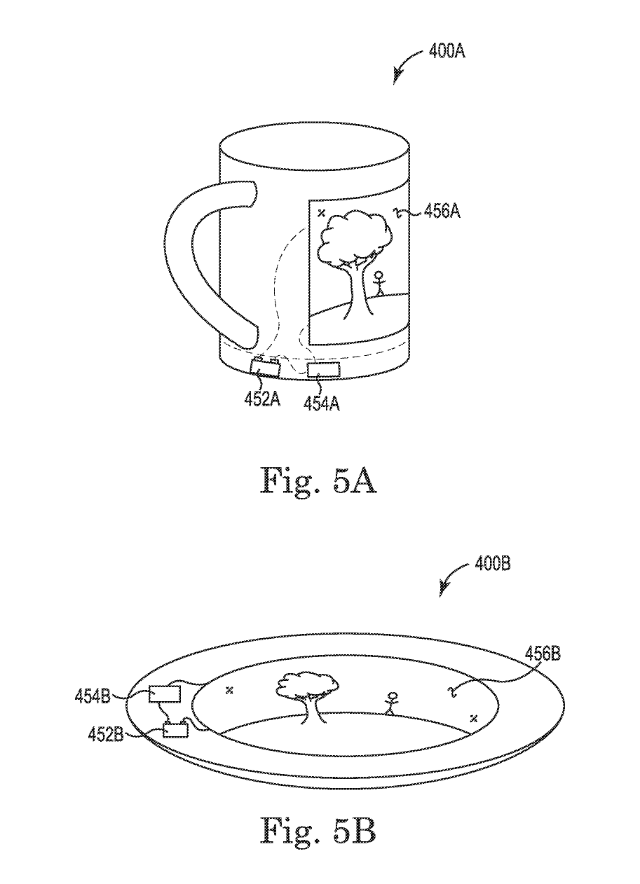

In still further keeping with the above, other embodiments of the invention comprise a display system including power supply 452, a controller 454, and an active element 456 as part of a molded product 400. For example, in one embodiments, an active element 456 such as a display 456 is arranged on a molded product 400 and incorporated into a surface of the molded product 400. In some embodiments, particular applications and uses of molded plastic parts that incorporate displays are provided. For example, one embodiment is a plastic cup 400A, as shown in FIG. 5A, with a display integrated 456A into the cup 400A. The plastic cup 400A might be shaped in different ways and used for drinking coffee or drinking wine. The plastic cup 400A may include a power supply 452A, a controller 454A, and a display 456A as previously described. The controller 454A or other aspects of the system may also include circuitry or features for communicating with a wireless device. In one embodiment, the circuit including the power supply 452A and the controller 454A, for example, may be arranged in the base of the cup 400A, or the circuitry may be arranged in the sidewall of the cup 400A. The communication ability of the controller 454A or circuit may allow a user to upload various slide shows of one's family and friends to the cup 400A; or one might upload written messages or artistic designs to the cup 400A; in still other embodiments, videos may be uploaded and played on the display 456A. In still other embodiments, the controller 454A may include sound capabilities and a speaker may be provided such that music and/or sound may be played by the cup 400A.

Another embodiment may include a plastic plate 400B, as shown in FIG. 5B, that is molded and incorporates a display 456B. Like the cup 400A, the circuitry may be arranged in the base of the plate 400B and it may include communication features allowing a user to upload slide shows or messages to the plate 400B. Another embodiment of the invention may include a plastic pen that is molded and incorporates a display. The circuitry in this embodiment may be arranged at or near the top of the pen, for example. In any of the above embodiments, while not shown, the circuitry may include a rechargeable power supply and, as such, a port or other plug may be provided in electrical communication with the circuitry to recharge the battery.

Like the wearable displays described above, application software may be made available such that a user may download display information in the form of designs, slide shows, videos and the like. In some embodiments a mobile app may be provided such that the molded product may be placed in communication with a smartphone, for example, and the display of the molded article may adjusted based on information received from the smartphone.

In light of the above series of displays, the content displayed on the products may be subject to intellectual property rights such as copyright, trademark, and publicity rights. Moreover, unlike current downloading performed by individuals, the present series of products may implicate copyright rights relating to public performance and the like. In some embodiments, individuals may generate materials that can be copyrighted for use in modifiable display products. For example, individuals may upload pictures to an electronic vest, shirt, or other wearable item. Similarly, an individual might generate a unique design to upload to his/her electronic tie. Individuals utilizing electronic wear may also seek to incorporate trademarked terms into their electronic wear. For example, the owner of an electronic hat may seek to program the hat to say “Dodgers” when he attends a Dodgers baseball game, and then program the same hat to say “Lakers” when he attends a basketball game. Large corporations and brands generally own popular trademarks that people may seek to use in electronic wear. Finally, individuals may seek to incorporate pictures of individuals in their electronic wear, where rights of publicity may be implicated. For example, an individual with an electronic vest may wish to display a picture of a certain celebrity on the vest.

There is a need for a system for enabling holders of intellectual property rights to license their intellectual property rights and associated materials to third parties desiring to use the material in their own electronic wear. For example, if a person is wearing an electronic tie that is displaying a copyrighted design and another person wishes to use the same design in his/her own electronic tie, a system is needed for the latter person to obtain a license to use the copyrighted design.

One embodiment of the invention is a database for storing content that can be licensed for use as electronic wear. The database can include content subject to intellectual property protection supplied by brands, professional design firms, professional photographers, writers and poets, and ordinary individuals. In order for content to be registered in the database, the generator of the content may provide particular information and make particular representations and warranties regarding ownership and ability to license to third parties. Each piece of content may be assigned a specific electronic ID.

Another embodiment of the invention is a system and methods for enabling copyright holders to license their copyrights to third parties wishing to use the copyrights in similar electronic articles. The system may include an interface between the electronic wear, mobile devices, and a website supported by a database on a server (or an “App” related to the database). An individual can visit the web site (or accompanying App) and obtain a legal license to the content as well as physical access to the content.

In a specific embodiment, the system enables owners of content to selectively decide and negotiate the terms and conditions for licensing the content to third parties for use in electronic wear and/or products. For example, the owner of particular original content (for example, design or picture) subject to copyright protection may display the material in an electronic vest or an electronic tie. A third party may wish to utilize the design or picture for his or her own purposes, including (but not limited to), displaying the design or picture in her electronic wear. The third party can use her mobile device to communicate with the electronic wear to determine if the design or image has been registered in the system. That is, the electronic wear may store an indication of registration in the system and may further include a web address to direct the third party if the copyright is registered. In other embodiments, the electronic wear may store an ID and the third party mobile device may communicate with the electronic wear of the copyright owner or other wearer to access the ID and may, in turn, communicate with the database via the website to determine if the copyright is registered in the system. If the copyrighted content has been registered in the system, the third party may be directed to a web site or mobile interface that enables the third party to either: (1) pay for a license if license terms have already been set; or (2) make an electronic offer to the copyright holder to obtain a license. The copyright holder may be alerted (via text message, email, or other mechanism) that a third party has licensed or is making an offer to license the copyrighted content. If the copyrighted material has not been registered in the system, the system will notify the person wearing the electronic wear that a third party is interested in licensing the material. The system may inform the person wearing the electronic wear that, if he wishes to license the material, he must register the material as copyrighted material in the system. If a deal is formed for the copyright, the content may also be downloaded from the system.

In a different embodiment, the owners of content may agree to a standardized set of terms and conditions to register their content in the database for licensing to third parties. For example, each owner may agree to license each unique set of content for $1.00 to third parties that wish to license and download the content. In still other embodiments, some copyright owners may actively negotiate prices for their copyright while other owners agree to a set price for content. In some embodiments, agreeing to a set price may include agreeing to varying set prices depending on the content being provided. For example, more prominent Trademarks or Copyrights may agree to a higher set price than lesser known Trademarks or Copyrights, for example. In still other embodiment an algorithm may be provided to increase the price of the content as the demand for the content increases. In some embodiments, the increasing price may trail the demand slightly to avoid over pricing the content. Still other embodiments may be provided for pricing and/or negotiating content costs.

For purposes of this disclosure, any system described herein, for example the licensing system or the several systems of wearable displays and/or molded product displays, may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A modifiable display device, comprising:
a wearable article;
a power supply arranged on the wearable article;
an active element arranged on a surface of the wearable article; and
a controller in electrical communication with the power supply and the active element and configured to control the appearance of the active element.

2. The modifiable display device of claim 1, wherein the active element is a display.

3. The modifiable display device of claim 2, wherein the display is a flexible display.

4. The modifiable display device of claim 3, wherein the flexible display is an organic LED display.

5. The modifiable display device of claim 4, wherein the flexible display is an electrophoretic display.

6. The modifiable display device of claim 5, wherein the wearable article is a necktie having a surface.

7. The modifiable display device of claim 6, wherein the display comprises a portion of the surface of the necktie.

8. The modifiable display device of claim 7, wherein multiple displays are provided on the surface of the necktie.

9. The modifiable display device of claim 7, wherein the display comprises the full outwardly showing surface of the tie.

10. The modifiable display device of claim 1, wherein the wearable article is footwear.

11. The modifiable display device of claim 1, wherein the active element is a multi-layered coating configured to change colors based on a charge applied to the coating.

12. The modifiable display device of claim 11, wherein the controller is a variable resistor.

13. The modifiable display device of claim 12, wherein the footwear includes a shoe.

14. The modifiable display device of claim 1, wherein the controller is configured for input and output communication with a smartphone.

15. A modifiable display device, comprising:
a molded product;
a power supply arranged on the molded product;
an active element arranged on a surface of the molded product; and
a controller in electrical communication with the power supply and the active element and configured to control the appearance of the active element.

16. The modifiable display device of claim 15, wherein the molded product includes a thermoformed product and the active element is arranged within the molded volume of the molded product and at the surface of the molded product.

17. The modifiable display device of claim 16, wherein the molded product is a cup.

18. A system for managing content and intellectual property rights therein for modifiable display devices, comprising:
a central database having content stored thereon, the content being associated with an identification;
a registration confirmation module stored on the database and adapted to receive information over a network, compare the information to content and associated identifications in the database, and confirm registration with the system; and
a license module configured to establish a license between a user and an owner of copyright of the content.

19. The system of claim 18, wherein the license module is configured to establish a license based on a pre-selected price.

20. The system of claim 20, wherein the license module is configured to coordinate notifications and inputs from the interested user and the copyright owner to negotiate an agreed upon price for the copyright.
